(19) United States
(12) Patent Application Publication
(10) Pub. No.: US 2014/0326209 A1
(43) Pub. Date: Nov. 6, 2014

(54) END HOUSING FOR AN INTERNAL COMBUSTION ENGINE

(71) Applicant: ELECTRO-MOTIVE DIESEL, Inc., La Grange, IL (US)

(72) Inventors: Abhinav Reddy Pamulaparthy, Aurora, IL (US); Nicholas Denman Norris, Chicago, IL (US)

(21) Appl. No.: 14/335,265

(22) Filed: Jul. 18, 2014

(51) Int. Cl. F02F 7/00

(52) U.S. Cl. CPC F02F 7/0021
USPC 123/195 R

(57) ABSTRACT

An end housing for mounting on an engine block to support at least one engine accessory is provided. The end housing includes a mounting body with a first side attachable to the engine block and a second side to attach the at least one engine accessory. The mounting body includes: a ledge surface disposed in the first side and structured to align the first side with the engine block, a mounting perimeter defined by the second side of the mounting body, at least one lubrication pipe disposed within the mounting body, at least one cooling pipe disposed within the mounting body, and at least one accessory attachment surface defined by the second side of mounting body.

### TECHNICAL FIELD

The present disclosure relates generally to internal combustion engines. More specifically, the present disclosure relates to an end housing for an internal combustion engine.

### BACKGROUND

Internal combustion engines may have various engine accessories, such as: generators, power steering pumps, air conditioning compressors, engine coolant pumps, exhaust air pumps, condensers, and/or turbochargers. The engine accessories assist in the operation of the internal combustion engine. It has been a common practice to mount the engine accessories on a front block portion of the internal combustion engine. The engine accessories may be mounted on various brackets, which are adapted to house various sizes of the engine accessories. The position of the engine accessories may be varied based on different applications of the engine accessories. In addition to accessories and bracket structures to mount these accessories, many engines also requires space for routing coolant hoses, piping and hose brackets.

U.S. Pat. No. 6,244,239 describes an integrated housing to mount all the basic engine auxiliaries and secondary chassis related engine accessories of a typical automotive engine. The integrated housing is mounted to a single surface of an engine block to provide the strength and rigidity required to carry the loads of the engine accessories. In addition, the integrated housing is mounted in a way to offer the most appropriate location of the engine accessories relative to each other. However, optimization of mounting spaces for the engine accessories mentioned in the above-mentioned patent creates a concern for mounting space for oil pipes and coolant pipes.

### SUMMARY OF THE INVENTION

The present disclosure relates to an end housing mounted on an engine block to support at least one engine accessory also mounted thereto.

In accordance with the present disclosure, the end housing includes a mounting body with a first side attachable to the engine block and a second side attached to the at least one engine accessory. The mounting body includes: a ledge surface disposed in the first side and structured to align the first side with the engine block, a mounting perimeter defined by the second side of the mounting body, at least one lubrication pipe disposed within the mounting body, at least one cooling pipe disposed within the mounting body, and at least one accessory attachment surface defined by the second side of mounting body. The at least one accessory is mountable to the at least one accessory attachment surface. The at least one accessory is structured and arranged to fluidly connect to the accessory through the at least one lubrication pipe. Similarly, the at least one accessory is structured and arranged to fluidly connect to the accessory through the at least one cooling pipe.

In accordance with the disclosure, the end housing further includes a plurality of engine accessories. The plurality of engine accessories do not extend beyond the mounting perimeter of the mounting body, due to the plurality of engine accessories mounted to the mounting body.

### BRIEF DESCRIPTION OF THE DRAWINGS

FIG. 1 illustrates a perspective view of an engine mounted with an end housing, in accordance with the concepts of the present disclosure;

FIG. 2 illustrates a perspective view of a mounting body of the end housing of FIG. 1, in accordance with the concepts of the present disclosure; and

FIG. 3 illustrates a perspective view of the mounting body of FIG. 2, in accordance with the concepts of the present disclosure.

### DETAILED DESCRIPTION

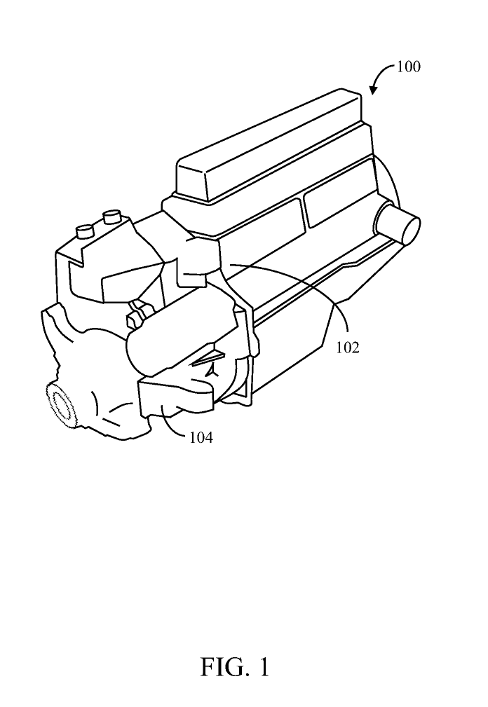

Referring to FIG. 1, there is shown an engine 100 mounted with an end housing 102. The engine 100 may include an engine block 104. The engine 100 may be coupled to the end housing 102. The end housing 102 may be utilized with any engine, such as vehicle, marine, and/or stationary engines. The end housing 102 may be attached to the engine 100 at a single mounting surface. The preferable mounting surface that attaches the end housing 102 to the engine 100 may be a front face of the engine block 104. However, without limiting the disclosure, the end housing 102 may alternatively be mounted to other surfaces of the engine 100, or to more than one engine surface, dependent upon the design criteria.

The shape and configuration of the end housing 102 is based on the engine 100, to which the end housing 102 is to be mounted. For example, if the end housing 102 were utilized with a radial engine, the end housing 102 would be designed and configured differently than if the end housing 102 were to be mounted to a different engine configuration. It is contemplated that the design of the end housing 102 may vary along with the location of the engine accessories and still achieves the objective of the present disclosure. It therefore should be understood that the end housing 102 of FIG. 1, is merely for illustrative purposes only, in accordance with the present disclosure.

The end housing 102 may be constructed of materials, such as cast iron or steel, forged steel or other suitable alternative materials that produce high durability and low noise during engine operations. In addition to noise characteristics, other factors, such as cost and weight, may be taken into account during a selection of the material. The end housing 102 may be manufactured by stamping, casting, welding, or other method that may provide a relatively stiff structure to the end housing 102.

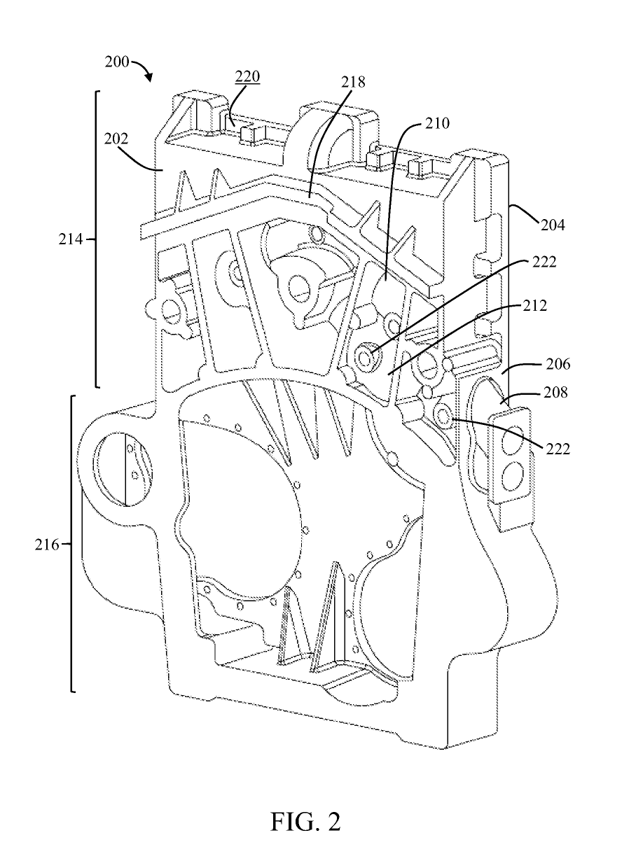

Referring to FIG. 2, there is shown a mounting body 200 of the end housing 102 (FIG. 1). The end housing 102 has a construction to mount all of the major engine accessories or components to the mounting body 200.

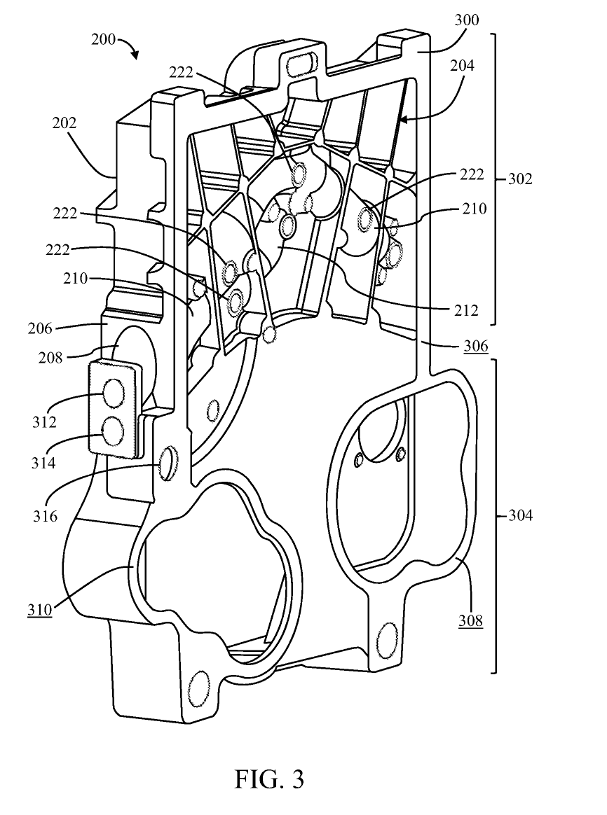

The mounting body 200 includes a first side 202, a second side 204, a lateral side 206, a first coolant pipe 208, a second coolant pipe 210, at least one lubrication pipe 212, and a plurality of holes (not shown). The second side 204 is shown in detail in FIG. 3.

The first side 202 is attachable to the engine block 104 by a plurality of fasteners (not shown). The plurality of fasteners (not shown) extends through a perimeter portion of the first side 202 and is positioned away from the accessory mounting surfaces. Hence, the mounting body 200 is then fastened to the engine block 104 by the fasteners (not shown). Also, the mounting body 200 is sealed to the engine block 104 by an O-ring seal or a gasket.

The first side 202 includes a first segment 214 and a second segment 216. The first segment 214 includes a ledge surface 218 and a first accessory attachment surface 220. The ledge surface 218 on the first segment 214 is provided to assist in the assembly of the mounting body 200 to matching machined components of the engine block 104. The ledge surface 218 acts as an alignment feature, thereby eliminating the need for dowels, alignment pins, or other alignment tools. The first accessory attachment surface 220 is disposed in the first segment 214, to allow attachment of a turbocharger or other engine accessory onto the engine 100. Since, the turbocharger (not shown) does not have a liquid interface; hence the turbocharger (not shown) is bolted or fastened onto the first accessory attachment surface 220.

The first side 202 may include a groove (not shown), to accommodate a single O-ring seal or multiple O-ring seals. When the first side 202 is bolted to the engine block 104, the O-ring seal provides a fluid-tight seal of the first side 202 to the engine block 104 and an oil pan (not shown). The groove (not shown) may also accommodate a single gasket seal, multiple gasket seals, or other similar seals known in the art. It may be contemplated that the first segment 214 and the second segment 216 may be sealed independently, when bolted to the engine block 104.

The mounting body 200 is attached to the engine block 104 by bolts, or the like, that are fitted in the plurality of holes (not shown) along a surface of the first side 202, which is attached to the engine block 104.

Referring to FIG. 3, there is shown the second side 204 of the mounting body 200. The second side 204 includes a mounting perimeter 300, a first portion 302 and a second portion 304. The mounting perimeter 300 is disposed in an outer boundary of the second side 204. The first portion 302 of the mounting perimeter 300 includes a second accessory attachment surface 306. The second accessory attachment surface 306 is provided for attachment of at least one intercooler (not shown) or other engine accessory. Since, the intercooler (not shown) does not have a liquid interface, hence the intercooler (not shown) is bolted or fastened onto the second accessory attachment surface 306. Further, the second portion 304 includes a third accessory attachment surface 308 and a fourth accessory attachment surface 310. The third accessory attachment surface 308 accommodates a coolant pump (not shown). The coolant pump (not shown) requires liquid interface and hence, the coolant pump (not shown) is equipped with the sealant or the gasket to provide a liquid-tight sealing with the third accessory attachment surface 308. The coolant pump (not shown) includes mounting plates, which are then fastened onto the third accessory attachment surface 308. The fourth accessory attachment surface 310 is provided to accommodate an oil pump (not shown). The oil pump (not shown) requires liquid interface and hence, the oil pump (not shown) is equipped with the sealant or the gasket to provide a liquid-tight sealing with the fourth accessory attachment surface 310. The oil pump (not shown) includes mounting plates, which are then fastened onto the fourth accessory attachment surface 310.

In an embodiment, the engine accessories are mounted at the first portion 302 and the second portion 304 of the second side 204 in a way, such that the engine accessories are confined to the plane of the mounting perimeter 300.

The first side 202 and the second side 204 define the lateral side 206 of the mounting body 200. The lateral side 206 may define a first coolant port 312 and a second coolant port 314. Similarly, the second side 204 may define an oil port 316. The first coolant port 312 and the second coolant port 314 allow entry of the coolant in the end housing 102. The first coolant port 312 and the second coolant port 314, respectively, are in fluid communication with the first coolant pipe 208 and the second coolant pipe 210. Similarly, the oil port 316 on the lateral side 206 is in fluid communication with the lubrication pipe 212. The first coolant pipe 208 and the second coolant pipe 210 are positioned at an inclination, such that, the coolant always drains out of the first coolant pipe 208 and the second coolant pipe 210. Hence, in cold conditions, when the engine 100 is not operational, the damage to the first coolant pipe 208 and the second coolant pipe 210 due to freezing of the coolant, is avoided. Further, each of the first coolant pipe 208 and the second coolant pipe 210 may include a plurality of freeze plugs 222. During the manufacturing of the first coolant pipe 208 and the second coolant pipe 210, the plurality of freeze plugs 222 are used to hold the first coolant pipe 208 and the second coolant pipe 210 in place.

It is envisioned that given the number of options that are offered with a particular machine, it may not be practical to mount all the engine accessories to the mounting body 200. In such a case, a predetermined number of engine accessories will be mounted to the mounting body 200. It should be understood that there may be a variation in location and number of engine accessories to be mounted on the mounting body 200. The engine accessories may include accessories as is customary, such as a vacuum pump, a fuel injection pump, an oil pump, a cam drive, a coolant pump, a cooler, a turbocharger and/or other engine accessories known to those having ordinary skill in the art.

### INDUSTRIAL APPLICABILITY

In operation, the mounting body 200 is equipped with a sealant or a gasket and thereby, prepared for mounting to the engine block 104. The mounting body 200 is then fastened to the engine block 104. The mounting body 200 includes the attachment surfaces for all the bolted-on-engine accessories. The arrangement and layout of the attachment surfaces in the mounting body 200 allows for the accommodation of the necessary components, such as the coolant pump, the oil pump, the turbocharger, the intercooler, and/or the like. The engine accessories, such as the coolant pump (not shown) and the oil pump (not shown), require liquid interface. Hence, the coolant pump (not shown) and the oil pump (not shown) are equipped with the sealant or the gasket. Thereafter, the coolant pump (not shown) and the oil pump (not shown), respectively, are bolted-on to third accessory attachment surface 308 and the fourth accessory attachment surface 310. The engine accessories, such as the turbocharger (not shown) and the intercooler (not shown) do not require liquid interface. Hence, the turbocharger (not shown) and the intercooler (not shown), respectively, are bolted-on to the first accessory attachment surface 220 and the second accessory attachment surface 306. The arrangement of the above mentioned components in the disclosed end housing 102 provides a solution for space constraints for attachment of the first coolant pipe 208, the second coolant pipe 210, and the lubrication pipe 212. The disclosed end housing 102 includes the first coolant pipe 208 and the second coolant pipe 210. The first coolant pipe 208 and the second coolant pipe 210 may serve as inlet pipes to the coolant pump (not shown), respectively, via the first coolant port 312 and the second coolant port 314. Similarly, the end housing 102 includes the lubrication pipe 212, which serves as the inlet pipe for the oil pump (not shown), via the oil port 316.

Hence, the disclosed end housing 102 provides an advantage of housing the necessary engine accessories along with accommodation of the first coolant pipe 208, the second coolant pipe 210, and the lubrication pipe 212. In addition, the end housing 102 is equipped with different attachment surfaces to mount the engine accessories in a way, such that the engine accessories are confined to the plane of the mounting perimeter 300. This is an advantage over conventional designs, which include individual drive accessories typically mounted directly to a surface of the engine, and coolant pipes and oil pipes mounted externally to the engine. Thus, the disclosed design of the end housing 102 eliminates the brackets provided for attachment of the engine accessories. The disclosed end housing 102 also eliminates the use of external coolant pipes and oil pipes in space constrained housing designs, by integrating the first coolant pipe 208, the second coolant pipe 210, and the lubrication pipe 212 into the end housing 102. The end housing 102 may be designed so that all the engine accessories may be preassembled as a total package that can be shipped, mated, and fastened to the engine as a single package. Further, the end housing 102 is designed to minimize the number of manufacturing machinery operations, tooling locations, minimization of material cost, and minimization of manufacturing cost.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. An end housing for mounting on an engine block to support at least one engine accessory mounted thereto, the end housing comprising:
a mounting body having a first side attachable to the engine block and a second side to attach the at least one engine accessory, the mounting body including:
a ledge surface disposed in the first side and structured to align the first side with the engine block;
a mounting perimeter defined by the second side of the mounting body;
at least one lubrication pipe disposed within the mounting body;
at least one cooling pipe disposed within the mounting body; and
at least one accessory attachment surface defined by the second side of mounting body, wherein the at least one accessory is mountable to the at least one accessory attachment surface, the at least one accessory being structured and arranged to fluidly connect to the at least one accessory through the at least one lubrication pipe, the at least one accessory being structured and arranged to fluidly connect to the accessory through the at least on cooling pipe.

2. The end housing of claim 1 further comprising a plurality of engine accessories, wherein substantially all of the plurality of engine accessories not being extended beyond the mounting perimeter of the mounting body in response to the plurality of engine accessories being mounted to the mounting body.
